(19) United States
(12) Patent Application Publication
(10) Pub. No.: US 2014/0321129 A1
(43) Pub. Date: Oct. 30, 2014

(54) LIGHT EMITTING DIODE MODULE

(71) Applicant: HON HAI PRECISION INDUSTRY CO., LTD., New Taipei (TW)

(72) Inventor: KAI-WEN WU, New Taipei (TW)

(73) Assignee: HON HAI PRECISION INDUSTRY CO., LTD., New Taipei (TW)

(21) Appl. No.: 14/056,966

(22) Filed: Oct. 18, 2013

(30) Foreign Application Priority Data
Apr. 24, 2013 (TW) 102114711

(51) Int. Cl. F21K 99/00; F21V 7/00

(52) U.S. Cl. CPC F21K 9/50; F21V 7/00
USPC 362/310

(57) ABSTRACT

An LED module includes a circuit board with circuit arranged thereon and an LED package mounted on the circuit board via flip-chip mounting. The LED package includes a substrate, a pin structure and a reflector arranged on the substrate, an LED chip disposed on the pin structure and an encapsulation layer covering the LED chip and received in the reflector. A top surface of the encapsulation layer adjacent to the circuit board acts as a light outputting surface. The pin structure extends from the substrate to a top surface of the reflector near the light outputting surface. The pin structure electrically connects the circuit board by conductive adhesive arranged therebetween. The light outputting surface faces a through hole defined in the circuit board. Light emitted from the LED chip travels through the light outputting surface and the through hole in sequence to illuminate.

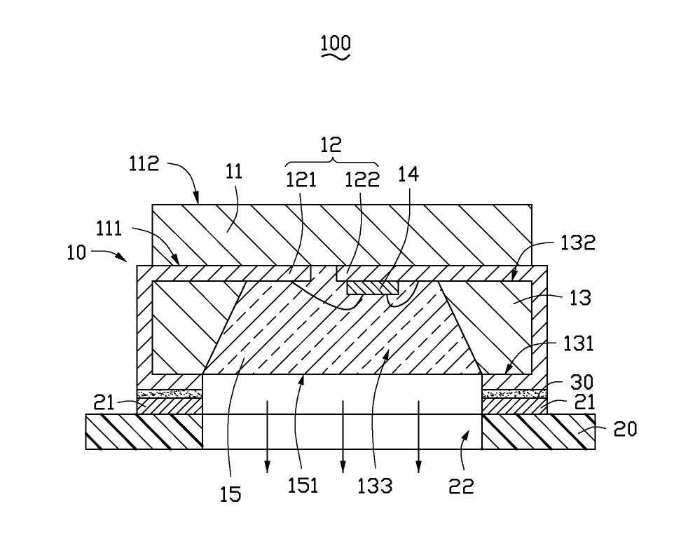

### BACKGROUND

1. Technical Field

The present disclosure generally relates to a semiconductor structure, and particularly to a light emitting diode (LED) module.

2. Description of the Related Art

LEDs have many advantages, such as high luminosity, low operational voltage, low power consumption, compatibility with integrated circuits, faster switching, long term reliability, and environmental friendliness which have promoted their wide use as a light source.

A conventional LED module includes a circuit board and an LED package mounted on the circuit board. The LED package includes two electrodes. For some LED packages with high power, flip-chip connection of the LED packages with the circuit boards requires a plurality of gold balls disposed on the two electrodes to electrically connect the LED package and the circuit board. However, the process of disposing the gold balls is complex. In addition, limited contacting areas between the gold balls and the electrodes decreases a heat dissipating efficiency of the LED package.

Therefore, it is desirable to provide an LED module which can overcome the above-described problems.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the present LED module. Moreover, in the drawing, the view is schematic, and like reference numerals designate corresponding parts throughout the whole view.

The only drawing is a cross-sectional view of an LED module in accordance with an exemplary embodiment of the present disclosure.

### DETAILED DESCRIPTION

Referring to the only drawing, an LED module 100 in accordance with an embodiment is provided. The LED module 100 includes an LED package 10 and a circuit board 20. The LED package 10 is mounted on the circuit board 20 by flip-chip bonding.

The LED package 10 includes a substrate 11, a pin structure 12 arranged on the substrate 11, an LED chip 14 arranged on the pin structure 12, an encapsulation layer 15 encapsulating the LED chip 14, and a reflector 13 receiving the LED chip 14 and the encapsulation layer 15 therein.

Specifically, the substrate 11 is flat. The substrate 11 includes a first surface 111 and a second surface 112. In this embodiment, the substrate 11 is electrically insulating.

The pin structure 12 is arranged on the first surface 111 of the substrate. The pin structure includes a first electrode 121 and a second electrode 122 separated from each other. Both the first electrode 121 and the second electrode 122 extend from the first surface 111 to a top surface 131 of the reflector 13 away from the first surface 111.

The reflector 13 includes the top surface 131 and a bottom surface 132 opposite to the top surface 131. A recess 133 is defined in a center of the reflector 13 and penetrates through the top surface 131 and the bottom surface 132. The LED chip 14 is received in the recess 132. A bore diameter of the recess 133 gradually decreases from the top surface 131 to the bottom surface 132. Highly reflective materials could be coated on the inner surface of the reflector 13 defining the recess 133. In this embodiment, the reflector 13 and the substrate 11 are integrally formed as a monolithic piece by injection molding method. The first electrode 121 and the second electrode 122 extend from the bottom surface 132 to the top surface 131 of the reflector 13. A dimension of a part of each of the electrodes 121, 122 located at the top surface 131 is much larger than that of traditional gold balls.

The LED chip 14 is arranged on one end of the first electrode 121 adjacent to the second electrode 122. The LED chip 14 electrically connects to the first electrode 121 and the second electrode 122 by electrically conducting wires. Alternatively, the LED chip 14 could also be mounted on the pin structure 12 by flip chip method.

The encapsulation layer 15 encapsulates the LED chip 14 and is fully filled in the recess 133 and surrounded by the inner surface of the reflector 13. A top surface of the encapsulation layer 15 is coplanar with the top surface 131 of the reflector 13 to form a light outputting surface 151. The encapsulation 15 is made of transparent materials such as silicone. Alternatively, the encapsulation layer 15 can also include fluorescent materials distributed therein.

The circuit board 20 is flat and provided with circuit 21 formed thereon. The circuit board 20 is electrically insulating. A through hole 22 is defined in an area of the circuit board 20 corresponding to the light outputting surface 151, and light emitted from the LED chip 14 travels through the light outputting surface 151 and the through hole 22 in sequence to illuminate. A shape and a dimension of the through hole 22 are the same as a shape and a dimension of the light outputting surface 151.

When the LED module 100 is assembled, the LED package 10 is inverted and mounted on the circuit board 20. That is the light outputting surface 151 faces to the circuit board 20. The light outputting surface 151 is spaced from the circuit board 20 and the through hole 22 by the first electrode 121 and the second electrode 122, the circuit 21 on the circuit board 20 and conductive adhesive 30 which mechanically and electrically connects the first and second electrodes 121, 122 and the circuit 21.

The first electrode 121 and the second electrode 122 extend to the top surface 131 of the reflector 13 and electrically connect to the circuit 21 via the conductive adhesive 30. Due to the dimension of each of the parts of the first electrode 121 and the second electrode 122 on the top surface 131 of the reflector 13 is much greater than that of the traditional gold balls, correspondingly the contacting area between the LED package 10 and the circuit board 20 is greater than the contacting area between the traditional gold balls and the circuit board 20. Accordingly a heat dissipating efficiency of the LED module 100 is increased.

In addition, since the light outputting surface 151 faces to the circuit board 20, when the LED module 100 works, light generated by the LED chip 14 radiates out by passing through the through hole 22 to satisfy some lighting requirements. Furthermore, since the LED package 10 and the circuit board 20 are electrically and mechanically connected together via the conductive adhesive 30 which can be easily applied to the circuit 21 or the first and second electrodes 121, 122, the manufacturing costs of the LED module 100 can be reduced.

It is to be understood that the above-described embodiments are intended to illustrate rather than limit the disclosure. Variations may be made to the embodiments without departing from the spirit of the disclosure. The above-described embodiments illustrate the scope of the disclosure but do not restrict the scope of the disclosure.

What is claimed is:

1. A light emitting diode (LED) module, comprising:
an LED package, the LED package comprising a substrate, a pin structure and a reflector arranged on the substrate, an LED chip arranged on the pin structure, and an encapsulation layer covering the LED chip and received in the reflector, a top surface of the encapsulation layer acting as a light outputting surface, the pin structure extending from the substrate to a top surface of the reflector near to the light outputting surface;
an insulated circuit board with circuit arranged thereon, the LED package being mounted on the circuit board, the pin structure electrically connecting the circuit on the circuit board by conductive adhesive arranged therebetween, the light outputting surface facing to and being spaced from the circuit board, a through hole being defined in an area of the circuit board corresponding to the light outputting surface, light emitted from the LED chip traveling through the light outputting surface and the through hole in sequence to illuminate.

2. The LED module of claim 1, wherein a shape and a dimension of the through hole are the same as a shape and a dimension of the light outputting surface.

3. The LED module of claim 1, wherein the substrate of the LED package is electrically insulating, the substrate and the reflector being integrally formed as a monolithic piece.

4. The LED module of claim 1, wherein the reflector comprises a bottom surface near the substrate and a top surface near the light outputting surface, the reflector defining a recess penetrating through the top surface and the bottom surface in a center thereof, the LED chip being received in the recess, the encapsulation layer being fully filled in the recess and surrounded by an inner surface of the reflector.

5. The LED module of claim 5, wherein the light outputting surface is coplanar with the top surface of the reflector, the pin structure comprising a first electrode and a second electrode separated from each other, a part of the first electrode and a part of the second electrode located at the top surface of the reflector electrically connecting with the circuit on the circuit board by conductive adhesive arranged between.

6. The LED module of claim 5, wherein the LED chip is arranged on an end of the first electrode adjacent to the second electrode, the LED chip electrically connecting with the first electrode and the second electrode via wires.
